(19) United States
(12) Patent Application Publication
(10) Pub. No.: US 2012/0303586 A1
(43) Pub. Date: Nov. 29, 2012

(54) SYSTEM AND METHOD FOR DATA INTEGRATION OF ENGINEERING TOOLS

(75) Inventors: Rainer DRATH, Weinheim (DE); Jens Hofschulte, Lehrte (DE)

(73) Assignee: ABB RESEARCH LTD, Zurich (CH)

(21) Appl. No.: 13/487,681

(22) Filed: Jun. 4, 2012

Related U.S. Application Data
(63) Continuation of application No. PCT/EP2009/008648, filed on Dec. 4, 2009.

(51) Int. Cl. G06F 17/30

(52) U.S. Cl. 707/649; 707/E17.005

(57) ABSTRACT

Exemplary embodiments of the present disclosure relates to a system and method for data integration using at least two independent engineering tools including their private database, where all data in the first tool being of interest for the second tool are identified, specified and stored in an electronic data container. Each data item stored in the electronic data container is provided with a link to the original data and with a copy of the stored data items. The electronic data container that includes the data items can be accessed by the target tool or a separate application to obtain a read-only view of the engineering data of the source tool for further use in the target engineering tool and navigation through the data for the engineer as well as for a data import.

### RELATED APPLICATION(S)

This application claims priority as a continuation application under 35 U.S.C. §120 to PCT/EP2009/008648, which was filed as an International Application on Dec. 4, 2009, designating the U.S., the content of which is hereby incorporated by reference its entirety.

### FIELD

The disclosure relates to data integration, such as a system and a method for a simplified data integration of engineering tools.

### BACKGROUND INFORMATION

The engineering of plants in manufacturing and/or process industry is characterized by a strong phase and tool separation. The separation has been formed in history because of the complexity of the plants and the need for work sharing. The separation has a strong fundament which is visible in different industry branches, education branches, institutes or conferences—and a strong engineering tool separation.

In each engineering phase, different engineers with different professions perform engineering tasks supported by different engineering tools. Different aspects of engineering data are created, hosted, and owned by different tools. However, these engineering data belong together and there is a need for data exchange between those tools and therefore data integration between them.

Consequently it is important to be aware of the fact that usually engineering data have a designated owner who is responsible for the data, e.g. the control engineer is responsible for the automation related data while the process engineer is responsible for the process related data.

With the data exchange from one tool to another these relations of ownership have strictly to be observed and any violations and/or unauthorized manipulations of data have to be avoided.

US 2009238309 A1 discloses an apparatus and a method for inter-channel data exchange in multi-channel data acquisition systems is disclosed. A multi-channel data acquisition system may include a data exchange layer coupling two or more channels of the data acquisition system. The data may be transmitted via the data exchange layer between the channels, enabling data from one channel to be processed and output by another channel. The data exchange layer may include serial or parallel communication means.

From U.S. Pat. No. 7,610,627 B1 a system and a method have become known which are utilizing common encryption approaches for data from multiple parties enable those parties to discover information that is held in common by the parties without disclosing to any party information that is not held in common by the parties. Encrypted information for each party can be compared to determine which encrypted values match, and those encrypted values can be returned to any of the parties such that a party can determine which corresponding data the parties have in common, without having access to any other data of any other parties.

US 2005246205 A1 discloses systems and methods for constructing a regional data exchange infrastructure that can provide the aggregation and presentation of personal data that previously exists in different organizations in a segmented fashion, i.e. establishing a regional data exchange infrastructure, identifying across multiple different organizations, creating patient medical data pointers and routing tables, and generating comprehensive data sets for an enrolled population. One feature of this present disclosure permits the regional data exchange infrastructure to be built without any protected information being stored in any centralized databases. Another feature of the teaching according to US 2005246205 A1 permits the continuous operation of the regional data exchange infrastructure even when the centralized facility experiences downtime. Exemplary embodiments of the present disclosure permit both local and global logging and tracking of data flows and user activities. Alternative embodiments of the present disclosure permit the preservation of the data ownership for the participating organizations.

Data exchange may be performed in various manners depending on the kind of data, on the branch where the data are used, and on the tools utilizing those data. The majority of engineering tools do not have any relationship to each other: they are independent with their own data storage and functionality.

The known methods for data exchange between independent tools suffer from the lack of allocation of the respective data with regard to the ownership of the data according to the responsibility for the correctness of these data. Automatic tracking of changes between those tools is not systematically available, manual tracking and change management is specified. This leads to high effort while tracking changes among a tool chain and in synchronization of data which is redundantly available in several engineering tools. If a single engineering data is changed in an early basic engineering phase, it may influence changes in the detail engineering of the PLC-, HMI-, robot-, process-, control or electrical engineering. The same may occur if a single engineering data is changed in a late implementation phase: this may call for a complete reengineering of all phases.

A tool suite aims to solve the mentioned issues, but a tool suite specifies a monolithic and at least coordinated development of all participating engineering tools which is not realistic in the commonly heterogeneous tool landscape. There is a need for a solution for data exchange between independent tools. A bidirectional data exchange without additional agreements and test steps would consequently lead to unauthorized data access and manipulations without preserving the ownership of the data.

### SUMMARY

An exemplary system for data integration in a unit having a robot system and stored program control is disclosed, comprising: at least two independent engineering tools each including a respective database, wherein all data items in a first engineering tool that are of interest to a second engineering tool is identified, configured, and stored in an electronic data container; a database provided with a link to the original data of each data item stored in the electronic data container and with a snapshot copy of each data item, wherein the electronic data container including said data items is imported by the second engineering tool or a separate application, which provides a read-only view of the imported data items within the second engineering tool and which allows importing the engineering data.

An exemplary method for data integration in a system having at least two independent engineering tools that include respective databases is disclosed, the method comprising: identifying all data items in the first engineering tool being of interest to the second engineering tool; configuring the identified data items; storing the configured data items in an electronic data container; providing a link of each data item stored in the electronic data container to original data items in the first engineering tool and with a copy of the data items stored in the electronic data container; opening and visualizing the electronic data container to provide a read-only view of the stored data items within the target tool; and importing the engineering data items through the second engineering tool.

### BRIEF DESCRIPTION OF THE DRAWINGS

The attached drawings show:

FIG. 1 an illustration of a data exchange scenario between independent tools in accordance with a known implementation;

FIG. 2 an illustration of a centralistic approach for data exchange between dependent in accordance with a known implementation;

FIG. 3 an illustration of a semi-centralistic approach for data exchange between dependent tools in accordance with an exemplary embodiment of the present disclosure;

FIG. 4 an illustration of a data integration system in accordance with an exemplary embodiment of the present disclosure; and

FIG. 5 a flowchart of a method of data integration in accordance with an exemplary embodiment of the present disclosure.

### DETAILED DESCRIPTION

Exemplary embodiments of the present disclosure provide a system and method of overcoming issues and mentioned drawbacks in order to establish a data integration between independent tools which is easier to handle, smart in function and simple and favorable in compilation when compared with prior art designs.

According to exemplary embodiments of the present disclosure a simplified integration technology system and method considers the directed unidirectional data exchange between two independent tools as a fundamental property.

An exemplary system for smart data integration, such as for manufacturing and/or processing purposes, e.g. in a unit including a robot system and a stored program control, is provided including (e.g., comprising) using an electronic data processing equipment, e.g. a computer, and at least two engineering tools which are independent including their private database, where all data in the first tool of interest for the second tool are identified and stored in an electronic data container, advantageously a file or a database e.g. being stored in a memory stick, provided with a link of the data stored in the electronic data container to the original data and with a snapshot copy of these data, and the electronic data container containing said data is opened by the target tool or a separate application providing a read-only view of the engineering data of the source tool for further use in the target engineering tool and a navigation through these data for the engineer as well as for a data import.

According to an exemplary embodiment of the present disclosure an electronic data processing unit, e.g. a computer, being combined with or including (e.g., comprising) a source engineering tool with a first engineering database are being provided to cooperate with a target engineering tool with a second engineering database where engineering data to be shared are specified in the source engineering tool, the specified data being stored in an electronic entity, advantageously a file or a database, and being provided for access to a target engineering tool B, where these specified data are prepared for visualization and navigation in the target engineering tool B, and are being used for engineering purposes in the engineering tool B.

According to an exemplary embodiment of the present disclosure, before establishing the data exchange, all data in the first tool of interest for the second tool have to be identified and configured, e.g. a list of signals or device objects. This is done e.g. in a configuration tool.

According to another exemplary embodiment of the present disclosure, the engineering data is provided in a read-only view which allows manual or algorithmic navigation and or visualization through the engineering data.

Other exemplary embodiments of the present disclosure provide that the engineering data of the first tool are connected and/or imported into the second engineering tool.

According to an exemplary embodiment disclosed herein, all imported engineering data is marked as being imported.

According to another exemplary embodiment, the marking of used information is fed back to the source engineering tool.

In an exemplary embodiment of the present disclosure, the owner of engineering data can determine which target engineering tools use published data of the first tool since the exemplary methods and systems provide all specified information. This concept can simplify the cooperation between the tools and engineers without data conflicts or violation of the data ownership.

Likewise the data integration is performed according to another exemplary embodiment such that the read-only view is additionally enabled for the determination and visualization of changes of the content of the source tool utilizing the link to the source data and thus preparing the update of corresponding data in the target tool.

A further exemplary embodiment of a system for data integration according to the present disclosure provides that the ownership of the shared data is implicitly designed to stick to the original tool.

An exemplary embodiment of the present disclosure, provides a unidirectional data view and navigation of engineering data of the source tool without any violation of the data ownership.

Another exemplary embodiment disclosed herein is directed to a unidirectional system that can be established in both directions in order to set up a bidirectional data exchange without violation of the data ownership.

Advantageously it is provided that specifications can be defined in the target tool B with regard to the target tool A and sent to the source tool A where these specifications are received as requests for changes of already published data or requests for publishing other data items. Those requests have to be processed by the data owner. This allows a feedback process and thus a bidirectional data exchange preserving data ownership conflicts.

A further exemplary embodiment of the present disclosure is that the second tool is a publication manager which is able to republish data provided by a data container. This allows collecting multiple data containers from different source engineering tools and to broadcast these data to other target tools.

Advantageously all established data containers within a network of engineering tools are stored together in a higher level electronic workflow data container for later reuse.

Furthermore the exemplary data container is provided for being used in order to connect a central database or a central repository.

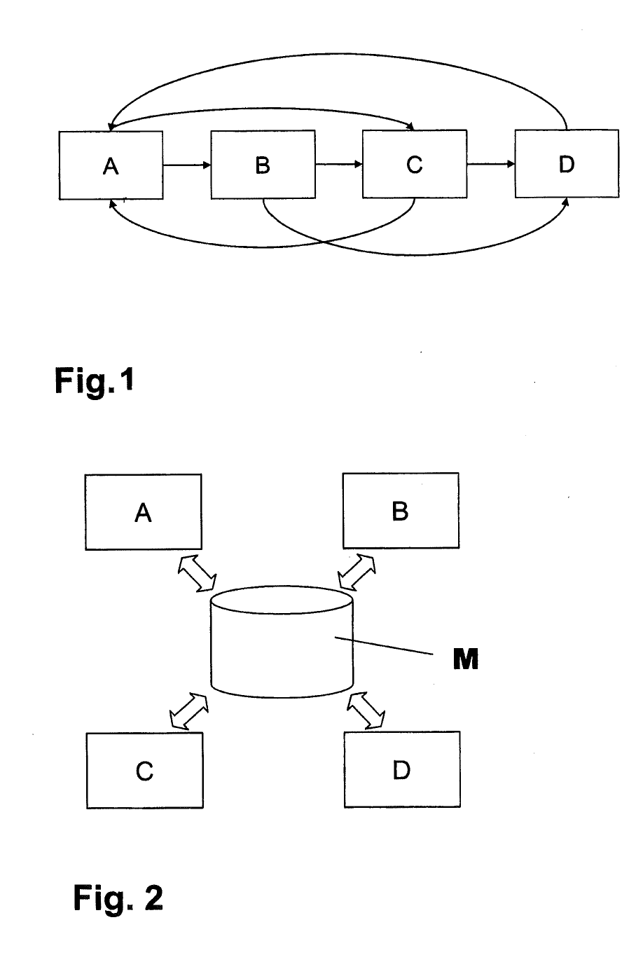

A further exemplary embodiment of the present disclosure provides that the data integration among several engineering tools, as depicted in FIG. 1, is automatically established by drawing arrows on a workflow diagram between the participating tools. This arrangement automatically configures the specified infrastructure for the data containers and hence allows a high level workflow design with automatic setup of the corresponding IT infrastructure.

Accordingly exemplary embodiments of the present disclosure relate to a method for data integration, such as for manufacturing and/or processing purposes, e.g. in a unit having (e.g., comprising) a robot system and a stored program control, according to the system described before where at least two independent engineering tools are used including their private database. As such, in the database which contains all data in the first tool being of interest for the second tool are identified, the data is configured and then stored in an electronic data container, advantageously a file or a database again being stored separately e.g. on a harddrive, an optical media, or a memory stick. This data container is provided with a link of each data item stored in the electronic data container to the original data and with a snapshot copy of these data.

According to an exemplary embodiment of the present disclosure the electronic data container containing said data is opened and visualized by the target tool or a separate application which provides a read-only view on the imported data within the target tool and which allows importing the engineering data.

Advantageously data in the first tool of interest for the second tool collected in an electronic data container and the respective data is provided for and/or imported into the target tool B.

An exemplary method disclosed herein includes the following steps:

a) The engineering data to be shared are specified at the source engineering tool.

b) The specified data is exported into an electronic entity, advantageously a file, or a database which can be stored on a harddrive, an optical media, or a memory stick.

c) In a third step the specified data is provided for access to a target engineering tool B.

d) The specified data are visualized in the target engineering tool B or a corresponding separate application.

e) The specified data is used for engineering purposes in the engineering tool B.

f) And finally in a seventh step each of said engineering data items is linked to the original data in engineering tool A.

According to an exemplary embodiment of the present disclosure, a method provides that the imported data is marked as being used by the target tool B and this information is fed back to the first engineering tool A, so that the data owner is automatically informed about who is using which of his published and/or provided data and in which tool.

Advantageously another exemplary method according to the present disclosure, all established data containers in a network of engineering tools are stored in common for later reuse in a higher level electronic workflow document.

In another exemplary method according to the present disclosure, the data integration is automatically established in several engineering tools while a workflow diagram including (e.g., comprising) the desired relations between the engineering tools is being developed, and whereas the containers for the desired data and communications are automatically created.

Furthermore any specifications or requests from the target tool can be transported to the source tool automatically by means of the data container. This allows a feedback process and thus a bidirectional data exchange without data access conflicts.

These features and further advantageous embodiments are contained in the claims and shall be illustrated by means of an example shown in the drawing attached to this specification.

FIG. 1 an illustration of a data exchange scenario between independent tools in accordance with a known implementation. FIG. 1 shows data exchange chain that can occur among different tools A, B, C, and D. For the manufacturing engineering, these tools may represent A as a mechanical engineering tool, B as a simulation tool, C as a PLC engineering tool and D as a robot engineering tool. For the process industry, A may represent a P&ID tool, B a control engineering tool, C an electrical engineering tool and D a documentation tool. The engineering chain does not follow a strict sequential workflow, i.e. changes occur in all phases but such impacts change to other tools. Therefore, a data exchange is specified in order to reach consistency—and this calls for tracking and validating those changes before the changes are executed.

There are three major ways to process a data exchange between them: either manually, or semi-automatically, or automatically. In all cases, the major challenge in data exchange is providing consistency between the engineering data across different tools. This can call for the tracking and management of changes across them. The majority of engineering tools do not have any relationship to each other: they are independent with their own data storage and functionality.

Manual data exchange can include re-entering data from one tool into the other by an engineer. It is responsible for the change management and the consistency of the result.

Semi-automatic data exchange can include transporting bulk data by means of electronic documents, e.g. XML files, spreadsheet files or other electronic documents. However, the data exchange is initiated by an engineer, who remains responsible for the change management and the consistency of the results while the data exchange is processed automatically.

Fully-automatic data exchange aims to avoid any human interaction: all data exchange is performed automatically including change management and consistency checks. Today, there is no fully-automatic data exchange system or method known, which allows tracking changes across independent tools or preserving the data ownership while data exchange.

With these three base methods the transport of engineering data from one tool to the other is executable where all methods should accomplish the need to observe the ownership and the responsibility issue and to provide individual solutions for it.

Different from a data exchange between independent tools is the data exchange between dependent tools. In that case, the engineering tools form a tool suite, and share knowledge about each other and are software integrated. There are two major variants for this approach, the centralistic approach and alternatively the semi-centralistic approach.

FIG. 2 an illustration of a centralistic approach for data exchange between dependent in accordance with a known implementation. In particular, FIG. 2 shows a centralistic approach in which all engineering tools A, B, C, and D share the same database M.

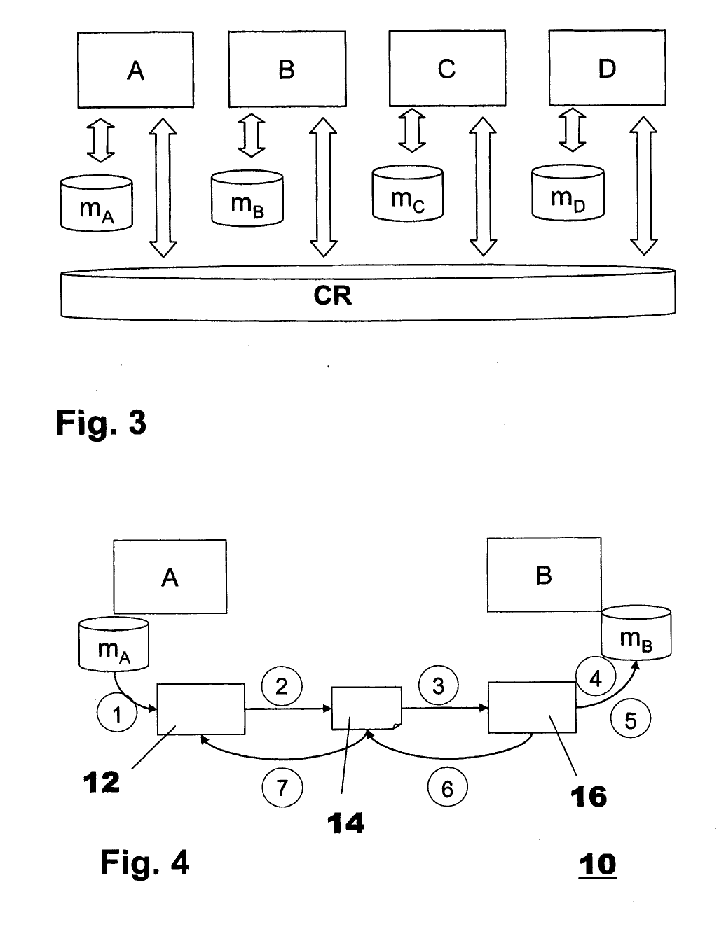

FIG. 3 an illustration of a semi-centralistic approach for data exchange between dependent tools in accordance with an exemplary embodiment of the present disclosure. For example, FIG. 3 shows a semi-centralistic approach where the tools A, B, C and D have private databases mA, mB, mC, MD and only share particular data in a common database CR, e.g. a central repository. In both cases, the tools are dependent from each other and changes of the tools may affect the remaining tools or a redesign of the database.

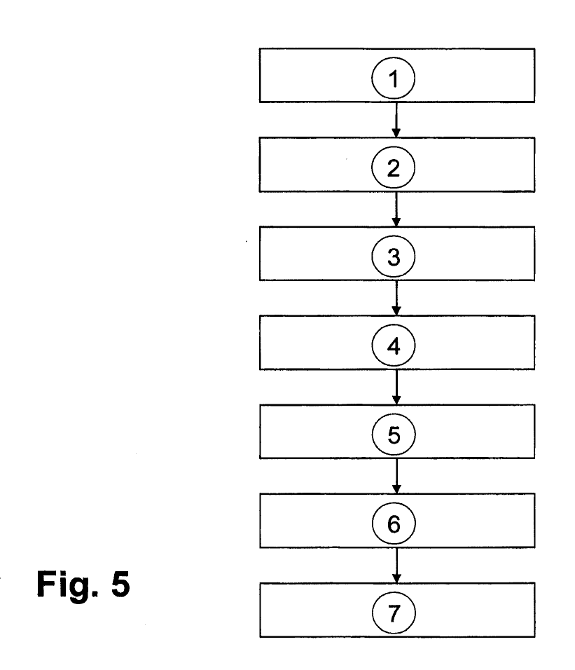

FIG. 4 an illustration of a data integration system in accordance with an exemplary embodiment of the present disclosure. FIG. 5 a flowchart of a method of data integration in accordance with an exemplary embodiment of the present disclosure. In FIG. 4, each step is related to the respective tools and media, and in FIG. 5, a flowchart is given comprising these steps in sequence.

Compared to the embodiments disclosed in the prior art it is easy to understand the significant advantage of using the exemplary embodiments disclosed herein in an industrial environment respectively for industrial purposes.

FIG. 4 exhibits an arrangement 10 including a first tool A, e.g. a PLC engineering tool, and a second tool B, e.g. a robot engineering tool. Each tool is connected to a data store i.e. memory A respectively memory B where the data is available.

In a first step, all data to be exchanged have to be defined in the PLC engineering tool A. This is done in a configuration tool 12. As a technical example, the engineering data is a list of signal objects provided by the PLC engineering tool including one signal object “WorkPieceDetected” with the attributes “Data type=Bool” and “Value=True” and “Color=Blue”. The definition of the data is with the responsibility of the PLC engineer who is the data owner. The results of this configuration may be re-used in the same or in other projects.

In a second step the corresponding engineering data is exported from the PLC engineering tool A into a data container 14, i.e. an electronic document which contains a copy of those data including a link for each data item to the original data. This document may be distributed by a storage means, e.g. a USB-stick, or via network, Email, or hard disc. As a technical example, the signal object “WorkPieceDetected” is stored as XML data structure representing the signal object and its corresponding attributes and their current values. Additionally, a link to the original data is stored as part of the signal object, e.g. “link=ToolA/ProjectStructure/Signals/WorkPieceDetected”. This allows automatic examination of the original data. Thus, a snapshot of the engineering data is stored as well as an information where this data comes from.

In a third step, this data container 14 is sent to the engineering tool B.

In a fourth step the data container is received by the engineering tool B or a separate application providing a read-only view 16 to the contained data. For instance, the signal object “WorkPieceDetected” and its current attributes are visualized and electronically accessible, whereas the link to the original allows verifying the consistency of this data. The ownership and responsibility of the engineering data is transparent, the data can be electronically or manually explored, filtered or observed. The link to the original data allows a determination of changes and their visualization in the robot tool B. In this example, the PLC signals are visualized for usage in the robot engineering tool and changed or added signals are highlighted. However, these data are only readable from the robot engineering tool B and there is no data synchronization functionality against tool A.

In a fifth step, the engineering data of interest are imported into the robot engineering tool B. The data stored in the data container and resulting from the PLC engineering tool can now be utilized in the robot program. In this example, the signal object “WorkPieceDetected” is automatically imported into the robot program and is connected to automation code that performs robot movements, e.g. gripping of the workpiece dependent on its attributes, e.g. . . . the robot transports blue workpieces on another work station than red workpieces.

The invented data integration system leads to a consistent data exchange from tool A to tool B without the drawbacks of the state of the art mentioned before and without demanding any dependencies between Tool A and B. Since the robot programmer cannot change the PLC engineering data, there is a systematic avoidance of data conflicts. The ownership and responsibility is assigned to the PLC or robot engineer in a transparent manner.

In a sixth step, all imported data are marked as being used. In the mentioned example, the signal object “WorkPieceDetected” gets an electronically marker “used=true” which is stored as additional attribute to the XML data container.

And in a seventh step, this information is fed back to the data owner tool A, which is capable of observing, which data item is used by which target application B. Due to this disclosure, on this example, the PLC engineering tool can automatically determine that the signal object “WorkPieceDetected” is being consumed and used in the robot programming tool B.

During engineering, exemplary embodiments disclosed herein allow the tracking of changes among independent tools, e.g. if the signal object “WorkPieceDetected” is renamed to “ProductDetected”, the PLC engineer can immediately observe respectively recognize that this signal object is used by the robot programming tool. Hence, any changes become detectable in this way and the software sends a notification as well as an updated data container to the engineering tool B. The robot programmer can immediately identify which data has changed and can perform adjustments in his code: in this example, the importer re-imports the changes and reconsolidates the consistency of the name of the signal object on all places in the robot programming tools B.

Beside use cases in the engineering, exemplary embodiments of the present disclosure are also applicable during the commissioning phase, the factory acceptance test (FAT) phase, the site acceptance test (SAT) phase or the plant operation phase. Because the exemplary embodiments disclosed herein allow the tracking of changes, it serves for the consistency of the data including the names of engineering data items: this is a precondition for e.g. OPC servers for automatic connection and communication between different devices which are configured by independent engineering tools.

While FIGS. 4 and 5 only describe for two tools A and B, in practice the number of engineering tools is higher and the technical advantages of this disclosure become even more visible considering FIG. 1 which presents a network of four engineering tools with different data exchange connections. According to the prior art, there is no systematic system or method known to track changes across independent engineering tools and tracking changes or the primary or secondary impact of changes is a tedious manual work. This disclosure allows systematic change detection and thus serves creating data consistency among independent tools.

An exemplary technical application of the present disclosure is in the process or manufacturing engineering. According to this disclosure, the data exchange between the engineering tools A, B, C and D follows reproducible technical steps which allow automatic identification of inconsistencies between the engineering data among independent engineering tools without the need of any software integration, e.g. if a signal object is changed in the PLC engineering tool, all other tools which use this signal object are automatically informed.

Another technical application is the operation of a plant. Here, the automation solution is fine-tuned according to practical aspects which lead to differences between the documented and the real automation solution. For example, in chemistry or pharmacy industry or in FDA conform production units, there is a need for consistency between the engineered and documented automation solution and the real automation system.

The general advantages of the disclosure are as follows:

All tools remain independent; no additional integration platform is specified. This reduces development effort, saves memory space and avoids dependencies.

The ownership of the shared engineering data and corresponding right management is well defined. This approach supports a simple but formalized engineering process with easy-to-use tool integration and clarified ownership and responsibilities by the data owners and avoids systematically redundancies and data conflicts.

Data integration is reached by a systematic forward publishing of data including change detection.

Only data of interest are published and/or provided for further usage and/or processing; this reduces the amount of software interaction and thus reduces the development effort.

Changes of published and/or provided data can be determined automatically by comparing the copy and the original data following the data link provided by the data container.

The disclosure reduces test and commissioning effort because the engineering data automatically fit together since the data container provides a consistent data integration and allows tracking of the impact of changes in a data exchange chain.

Furthermore this approach reduces the overall engineering effort and the cost of poor quality because the cooperation between tools is established early and automatically.

Accordingly, solutions provided by the exemplary embodiments of the present disclosure allow project dependent and flexible tool integration with minimal integration effort during the project. Extensions of the integration can be done fast without changing the code of any integration tool.

The exemplary concepts disclosed herein supports the storage of multi-tool-projects including the electronic configuration files in a package. This can be re-used later as a pattern solution.

In a final step, the exemplary embodiments according to the present disclosure allows data specifications collection i.e. the engineer can formulate data specifications or change requests and send it back with the data container.

Any owner of engineering data can always pursue which other engineer uses which data in which tool while all specified information is available from the data container.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A system for data integration in a unit having a robot system and stored program control, comprising:
at least two independent engineering tools each including a respective database, wherein all data items in a first engineering tool that are of interest to a second engineering tool is identified, configured, and stored in an electronic data container;
a database provided with a link to the original data of each data item stored in the electronic data container and with a snapshot copy of each data item,
wherein the electronic data container including said data items is imported by the second engineering tool or a separate application, which provides a read-only view of the imported data items within the second engineering tool and which allows importing the engineering data.

2. The system according to claim 1, wherein the first engineering tool is a source engineering tool with a first engineering database and the second engineering tool is a target engineering tool with a second engineering database and
wherein:
engineering data items to be shared are specified at the source engineering tool,
the specified data items are exported to the first engineering database,
the exported data items are provided for access by a target engineering tool B;
the exported data items are accessed by the target engineering tool B or a corresponding separate application, and
the accessed data items are used for engineering purposes in the engineering tool B.

3. The system according to claim 1, wherein each of said engineering data items has a link to original data in an engineering tool A.

4. The system according to claim 1, wherein the shared data items are prevented from being changed or manipulated in the target engineering tool B without additional authorization and are prepared as having read only access.

5. The system according to claim 4, wherein the engineering data items are connected and/or imported into the second engineering tool B.

6. The system according to claim 1, wherein imported data items are marked as being used by the target tool B.

7. The system according to claim 1, wherein information about previously imported data items is fed back to the first engineering tool A.

8. The system according to claim 1, wherein the owner of a data container is automatically informed about who is using which of published data items of the owned data container and in which tool.

9. The system according to claim 1, wherein the read-only view is used for visualizing changes based on a difference calculation between the original data items utilizing the link and a snapshot copy of previously published engineering data items.

10. The system according to claim 1, wherein ownership of shared engineering data items sticks to the original tool.

11. The system according to claim 1, wherein the unidirectional data flow is established in both directions of the first and second engineering tool.

12. The system according to claim 1, wherein data specifications are defined in the target tool B with regard to a source engineering tool A and are sent to the source engineering tool A.

13. The system according to claim 12, wherein the data specifications are requests for changes of already published data items or requests for publishing other data items.

14. The system according to claim 1, wherein the target engineering tool is a publishing manager for a first data container and where data items of the first data container are republished to other tools.

15. The system according to claim 1, wherein all established data containers in a network of engineering tools are stored together in a higher level electronic workflow document for later re-use.

16. The system according to claim 1, wherein the data container is used in order to connect a central database or a central repository.

17. The system according to claim 1, wherein the data integration among several engineering tools is automatically established while developing a workflow diagram comprising desired relations between engineering tools, and wherein the data containers and communications are automatically created.

18. A method for data integration in a system having at least two independent engineering tools that include respective databases, the method comprising:
identifying all data items in the first engineering tool being of interest to the second engineering tool;
configuring the identified data items;
storing the configured data items in an electronic data container;
providing a link of each data item stored in the electronic data container to original data items in the first engineering tool and with a copy of the data items stored in the electronic data container;
opening and visualizing the electronic data container to provide a read-only view of the stored data items within the target tool; and
importing the engineering data items through the second engineering tool.

19. The method according to claim 18, wherein the first engineering tool is a source engineering tool with a first engineering database and the second engineering tool is a target engineering tool with a second engineering database comprising:
specifying, at the source engineering tool, the engineering data items to be shared;
exporting the specified data items to the first engineering database;
accessing the exported data items through a target engineering tool B;
visualizing accessed data items in the target engineering tool B or a corresponding separate application;
using the visualized data items for engineering purposes in the engineering tool B; and
linking each of said engineering data items to the original data in engineering tool A.

20. The method according to claim 18, comprising:
marking the accessed data items as being used by the target tool B and feeding the marked data items back to the first engineering tool A, so that an owner of the data items is automatically informed about who is using which of the data items of the owner and in which tool.

21. The method according to claim 18, comprising:
storing all established data containers in a network of engineering tools for re-use in a higher level electronic workflow document.

22. The method according to claim 18, comprising:
automatically establishing data integration in several engineering tools while a workflow diagram comprising the desired relations between the engineering tools is developed, and wherein the data containers and communications are automatically created.

23. A manufacturing or processing method for performing data integration according the method of claim 18 in a unit having a robot system and stored program control.
